(19) United States
(12) Patent Application Publication
(10) Pub. No.: US 2026/0292620 A1
(43) Pub. Date: Sep. 24, 2026

(54) RANDOM ACCESS CHANNEL (RACH)-LESS HANDOVER (HO) FOR NON-TERRESTRIAL NETWORKS (NTN)

(71) Applicant: APPLE INC., Cupertino, CA (US)

(72) Inventors: Fangli XU, Beijing (CN); Haijing HU, Los Gatos, CA (US); Yuqin CHEN, Beijing (CN); Jie CUI, San Jose, CA (US); Qiming LI, Beijing (CN); Chunxuan YE, San Diego, CA (US); Chunhai YAO, Beijing (CN); Dawei ZHANG, Saratoga, CA (US)

(73) Assignee: APPLE INC., Cupertino, CA (US)

(21) Appl. No.: 19/471,989

(22) PCT Filed: Apr. 4, 2023
(86) PCT No.: PCT/CN2023/086247

§ 371 Date: Oct. 2, 2025

(51) Int. Cl. H04W 36/00; H04W 76/38

(52) U.S. Cl. CPC H04W 36/00725; H04W 76/38

(57) ABSTRACT

Some aspects of this disclosure relate to apparatuses and methods for implementing mechanisms for Random Access Channel (RACH)-less handover for Non-Terrestrial Networks (NTN). For example, a user equipment (UE) is configured to receive, using a transceiver and from a source base station, a handover command to perform a Random Access Channel (RACH)-less handover operation to a target base station. The handover command includes a timing advance (TA) configuration. The UE is further configured to determine, based on the TA configuration of the handover command, a TA value for uplink (UL) transmission to the target base station. The processor is further configured to transmit, using the transceiver and to the target base station, an initial UL transmission based on the determined TA value.

### BACKGROUND

### Field

The described aspects generally relate to mechanisms for handover for Non-Terrestrial Networks (NTN).

### Related Art

A user equipment (UE) can move between Non-Terrestrial Networks (NTN), between Terrestrial Networks (TN), and/or between an NTN and a TN. The system can help the UE's movement by facilitating the handover between NTNs, between TNs, and/or between an NTN and a TN. In each network (e.g., NTN and/or TN), the UE can use timing advance (TA) to control the uplink transmission timing of the UE within that network. Therefore, the uplink transmissions from all UEs can be synchronized when the uplink transmissions are received by a base station (BS). The TA is a special command (e.g., notification) from the BS to UE to enable UE to adjust its uplink transmission. For example, the UE can start the transmission of an uplink (UL) frame in the TA value before a downlink (DL) frame is received at the UE.

### SUMMARY

Some aspects of this disclosure relate to apparatuses and methods for implementing mechanisms for Random Access Channel (RACH)-less handover for Non-Terrestrial Networks (NTN). According to some aspects, a user equipment (UE) supports the RACH-less handover in NTN, and both target and source cells/nodes support the RACH-less handover. According to some aspects, and as discussed in more detail below, the network (NW) indicates the RACH-less handover command to handover the UE to a target NTN cell. In the RACH-less HO command, the NW can provide a timing advance (TA) configuration of the target NTN cell. In some examples, the TA configuration of the target NTN cell can be provided in advance. The UE is configured to derive a TA value for the target NTN cell based on the TA configuration in the handover command. The UE applies the TA value and transmits an initial uplink (UL) transmission (e.g., a handover Complete) using a first valid Physical Uplink Shared Channel (PUSCH) resource. After the UE receives a NW response Medium Access Control (MAC) Control Element (CE), the UE can start the data transmission in the target NTN cell.

Some aspects of this disclosure relate to a user equipment (UE). The UE includes a transceiver configured to wirelessly communicate with a source base station and a processor communicatively coupled to the transceiver. The processor is configured to receive, using the transceiver and from the source base station, a handover command to perform a Random Access Channel (RACH)-less handover operation to a target base station. The handover command includes a timing advance (TA) configuration. The processor is further configured to determine, based on the TA configuration of the handover command, a TA value for uplink (UL) transmission to the target base station. The processor is further configured to transmit, using the transceiver and to the target base station, an initial UL transmission based on the determined TA value.

In some aspects, the TA configuration indicates that a TA value associated with the source base station is to be used. To determine the TA value for UL transmission to the target base station, the processor is configured to determine the TA value associated with the source base station and use the TA value associated with the source base station as the TA value for UL transmission to the target base station.

In some aspects, the TA configuration indicates one or more parameters of a TA value associated with the source base station that are to be used. To determine the TA value for UL transmission to the target base station, the processor is configured to determine the one or more parameters of the TA value associated with the source base station and use the one or more parameters of the TA value associated with the source base station to compute the TA value for UL transmission to the target base station.

In some aspects, the one or more parameters of the TA value associated with the source base station that are to be used include one or more of a common TA value, a UE specific TA value, or an initial time alignment value.

In some aspects, the TA configuration indicates the RACH-less handover without providing information regarding the TA value for UL transmission to the target base station. To determine the TA value for UL transmission to the target base station, the processor is configured to assume that an initial time alignment value has a value of 0 and compute a common TA value, a UE specific TA value, and a TA offset value. The processor is further configured to use the initial time alignment value, the common TA value, the UE specific TA value, and the TA offset value to compute the TA value for UL transmission to the target base station.

In some aspects, the TA configuration indicates a handover type that is being used for the RACH-less handover. To determine the TA value for UL transmission to the target base station, the processor is configured to compute the TA value for UL transmission to the target base station based on the handover type indicated in the TA configuration.

In some aspects, the processor is further configured to receive, using the transceiver and from the target base station, a response message confirming the RACH-less handover and perform data transmission to the target base station based on the determined TA value.

Some aspects of this disclosure relate to a method performed by a user equipment (UE) including receiving, from a source base station, a handover command to perform a Random Access Channel (RACH)-less handover operation to a target base station. The handover command includes a timing advance (TA) configuration. The method further includes determining, based on the TA configuration of the handover command, a TA value for uplink (UL) transmission to the target base station and transmitting, using the transceiver and to the target base station, an initial UL transmission based on the determined TA value.

Some aspects of this disclosure relate to a non-transitory computer-readable medium storing instructions. When the instructions are executed by a processor of a user equipment (UE), the instructions cause the UE to perform operations including receiving, from a source base station, a handover command to perform a Random Access Channel (RACH)-less handover operation to a target base station. The handover command includes a timing advance (TA) configuration. The operations further include determining, based on the TA configuration of the handover command, a TA value for uplink (UL) transmission to the target base station and transmitting, using the transceiver and to the target base station, an initial UL transmission based on the determined TA value. The operations further include receiving, from the target base station and in response to the initial UL transmission, a response message confirming the RACH-less handover and performing data transmission to the target base station based on the determined TA value.

This Summary is provided merely for purposes of illustrating some aspects to provide an understanding of the subject matter described herein. Accordingly, the above-described features are merely examples and should not be construed to narrow the scope or spirit of the subject matter in this disclosure. Other features, aspects, and advantages of this disclosure will become apparent from the following Detailed Description, Figures, and Claims.

### BRIEF DESCRIPTION OF THE FIGURES

The accompanying drawings, which are incorporated herein and form part of the specification, illustrate the present disclosure and, together with the description, further serve to explain the principles of the disclosure and enable a person of skill in the relevant art(s) to make and use the disclosure.

FIG. 1A illustrates an example system implementing mechanisms for RACH-less handover for NTN, according to some aspects.

FIGS. 1B-1E illustrate different exemplary scenarios of RACH-less handover for NTN, according to some aspects.

FIG. 2 illustrates a block diagram of an example system of an electronic device implementing mechanisms for RACH-less handover for NTN, according to some aspects.

FIG. 3 illustrates communications between a UE, a source base station, and a target base station for implementing RACH-less handover for NTN, according to some aspects.

FIG. 4 illustrates an example method for a system (for example, a UE) performing mechanisms for RACH-less handover for NTN, according to some aspects.

FIG. 5 illustrates an example method for a system (for example, a base station) performing mechanisms for RACH-less handover for NTN, according to some aspects.

FIG. 6 is an example computer system for implementing some aspects or portion(s) thereof.

The present disclosure is described with reference to the accompanying drawings. In the drawings, generally, like reference numbers indicate identical or functionally similar elements. Additionally, generally, the left-most digit(s) of a reference number identifies the drawing in which the reference number first appears.

### DETAILED DESCRIPTION

Some aspects of this disclosure relate to apparatuses and methods for implementing mechanisms for RACH-less handover for NTN. According to some aspects, and as discussed in more detail below, a network (NW) indicates the RACH-less handover command to handover the UE to a target NTN cell. In the RACH-less HO command, the NW can provide a timing advance (TA) configuration of the target NTN cell. In some examples, the TA configuration of the target NTN cell can be provided in advance. The UE is configured to derive a TA value for the target NTN cell based on the TA configuration in the handover command. The UE applies the TA value and transmits an initial uplink (UL) transmission (e.g., a handover Complete) using a first valid Physical Uplink Shared Channel (PUSCH) resource. After the UE receives a NW response Medium Access Control (MAC) Control Element (CE), the UE can start the data transmission in the target NTN cell.

In some examples, the aspects of this disclosure can be performed by a network and/or a UE that operates according to 5^{th} generation (5G) wireless technology for digital cellular networks as defined by 3rd Generation Partnership Project (3GPP). Additionally, or alternatively, the aspects of this disclosure can be performed by a network and/or a UE that operates according to the Release 15 (Rel-15), Rel-16, Rel-17, Rel-17 new radio (NR), Rel-17 NTN, Rel-18, Rel-18 NR, Rel-18 NTN, or others. However, the aspects of this disclosure are not limited to these examples, and one or more mechanisms of this disclosure can be implemented by other network(s) and/or UE(s) for RACH-less handover for NTN.

According to some aspects, the NTNs can refer to networks, or segments of networks, using an airborne or spaceborne vehicle for transmission. For example, spaceborne vehicles can include one or more Low Earth orbit (LEO) satellites, one or more Medium Earth orbit (MEO) satellites, one or more Geostationary orbit (GEO) satellites, Highly Elliptical orbit (HEO) satellites, and/or the like. In some examples, the airborne vehicles can include High Altitude Platforms (HAPS). However, the aspects of this disclosure are not limited to these examples and can include other NTNs.

According to some aspects, the NTNs can be used for a plurality of scenarios. Some exemplary situations where NTNs are used can include, but are not limited to addressing mobile broadband needs, addressing public safety needs in unserved/underserved areas, maritime, airplane connectivity, railway, or the like. However, the aspects of this disclosure are not limited to these examples and can include other scenarios where NTNs are used.

According to some aspects, the NTNs (e.g., NR NTNs with LEO and GEO) can be compatible to support HAPS and Air-To-Ground (ATG) scenarios. The NTN can use Frequency Division Duplex (FDD). However, Time Division Duplex (TDD) can also be applied to relevant scenarios such as, but not limited to, HAPS, ATG, or the like. According to some examples, earth fixed tracking area can be applied and the UEs can have global navigation satellite system (GNSS) capabilities. In some examples, transparent payload can be used and the handheld devices can be in Frequency Range 1 (FR1) (e.g., power class 3). Also, very small aperture terminal (VSAT) devices with external antenna can be at least in Frequency Range 2 (FR2) (e.g., using Radio Access Network (RAN) 1-3 specifications). However, the aspects of this disclosure are not limited to these examples.

According to some aspects, an NTN cell (e.g., a cell corresponding to the NTN) will cover a wider radio cell compared to a terrestrial network (TN) cell (e.g., a cell corresponding to the TN). In other words, in the NTN, the coverage of a cell or a beam is typically much larger than the cell in the TN. In a non-limiting example, the coverage of one NTN cell may be across multiple countries.

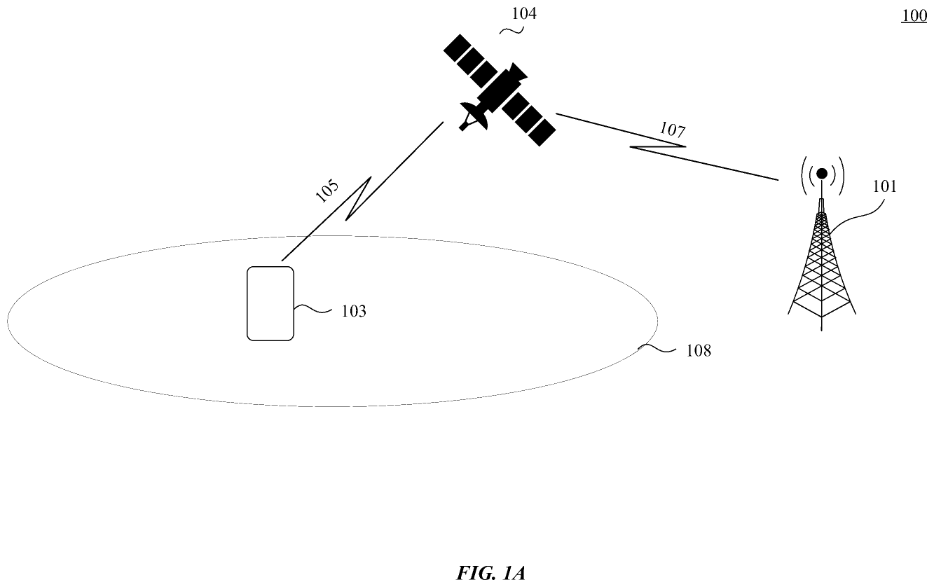

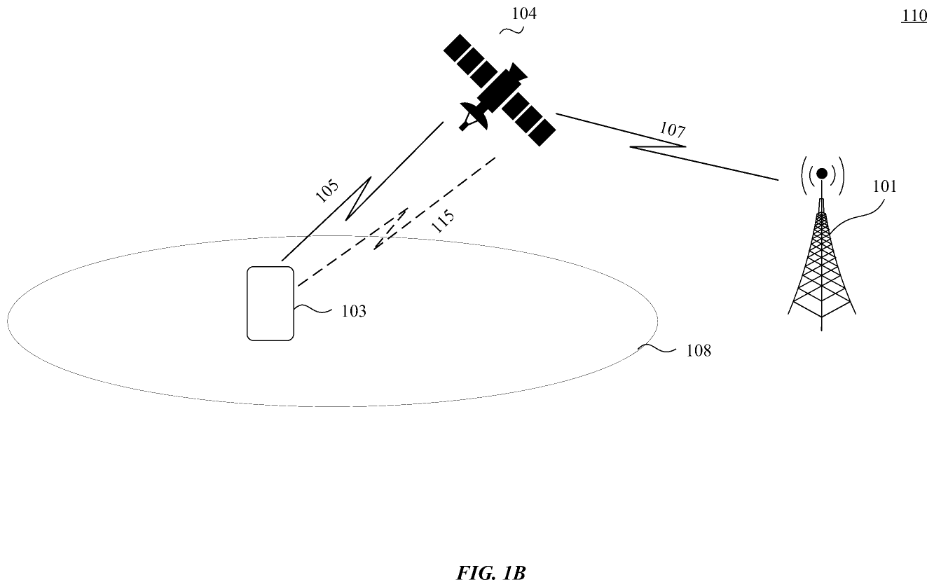

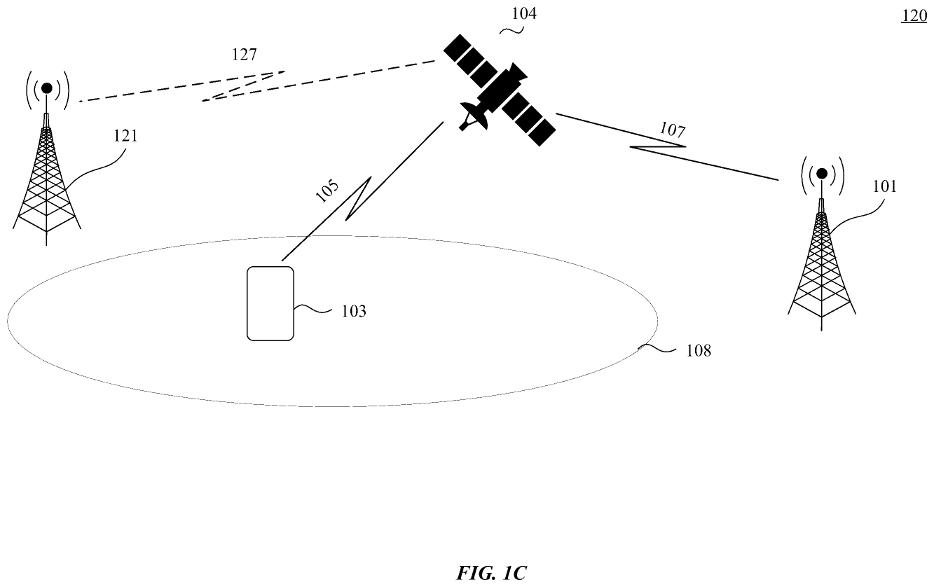

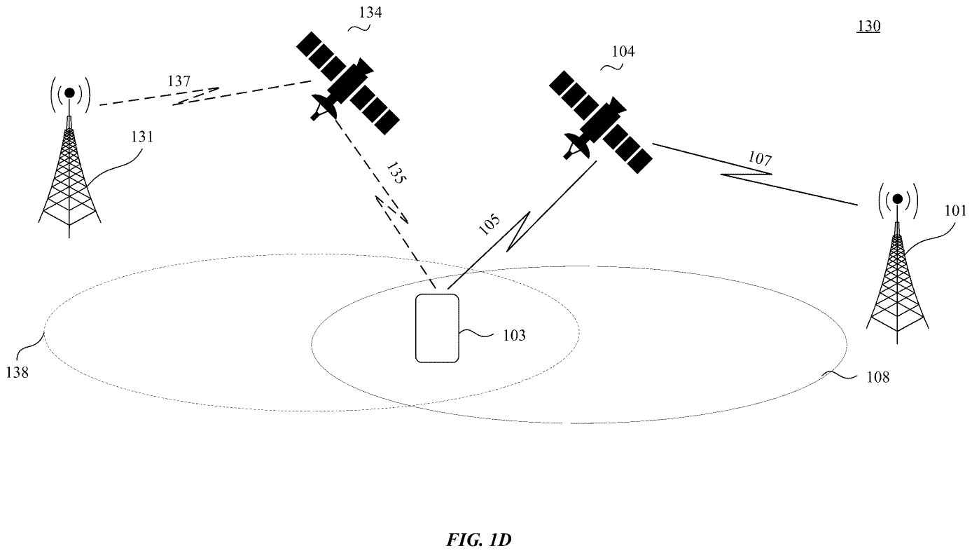

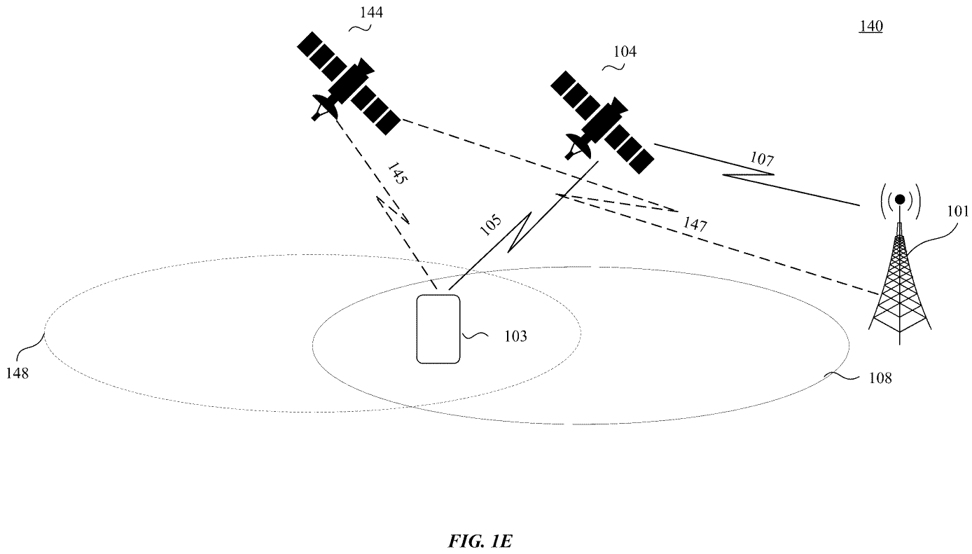

FIG. 1A illustrates an example system 100 implementing mechanisms for RACH-less handover for NTN, according to some aspects. Example system 100 is provided for the purpose of illustration only and does not limit the disclosed aspects. System 100 illustrates an example system that can implement the RACH-less handover. FIGS. 1B-1E illustrate different exemplary scenarios of RACH-less handover for NTN.

System 100 includes, but is not limited to, a network node (for example, a base station such as eNBs, gNBs, and the like) 101, an electronic device (for example, a UE) 103, and a satellite 104. The electronic device 103 can be configured to operate based on a wide variety of wireless communication techniques. These techniques can include, but are not limited to, techniques based on 3rd Generation Partnership Project (3GPP) standards. For example, the UE 103 can be configured to operate using Rel-15, Rel-16, Rel-17, Rel-17 NR, Rel-17 NTN, Rel-18, Rel-18 NR, Rel-18 NTN, or others. The UE 103 can include, but is not limited to, wireless communication devices, smart phones, laptops, desktops, tablets, personal assistants, monitors, televisions, wearable devices, Internet of Things (IoTs), vehicle's communication devices, and the like.

The network node 101 (herein referred to as a base station or a cell) can include one or more nodes configured to operate based on a wide variety of wireless communication techniques such as, but not limited to, techniques based on 3GPP standards. For example, the base station 101 can include one or more nodes configured to operate using Rel-15, Rel-16, Rel-17, Rel-17 NR, Rel-17 NTN, Rel-18, Rel-18 NR, Rel-18 NTN, or others. The satellite 104 can include one or more satellites as part of LEO satellites, MEO satellites, GEO satellites, HEO satellites, HAPS satellites, ATG satellites, or the like. The satellite 104 can be configured to operate based on a wide variety of wireless communication techniques such as, but not limited to, techniques based on 3GPP standards. For example, the satellite 104 can include be configured to operate using Rel-15, Rel-16, Rel-17, Rel-17 NR, Rel-17 NTN, Rel-18, Rel-18 NR, Rel-18 NTN, or others.

According to some aspects, the satellite 104 and the base station 101 are part of the NTN. The NTN can include one or more satellites 104 and one or more base stations 101. The base station 101 can be coupled to a core network (e.g., a 5G core network). The NTN can have a coverage area 108. According to some aspects, the UE 103 can be connected to and can communicate with the satellite 104 using a carrier 105 (also referred to herein as a service link). According to some aspects, the carrier 105 can include one carrier. Additionally, or alternatively, the carrier 105 can include two or more component carriers (CC). In other words, the UE 103 can implement carrier aggregation (CA). For example, the UE 103 can use multiple carriers for communication with the satellite 104. According to some aspects, the satellite 104 can be connected to and can communicate with the base station 101 using a carrier 107 (also referred to herein as a feeder link). According to some aspects, the carrier 107 can include one carrier. Additionally, or alternatively, the carrier 107 can include two or more component carriers (CC). In other words, the UE 103 can implement carrier aggregation (CA). For example, the UE 103 can use multiple carriers for communication with the base station 101 through the satellite 104.

According to some aspects, the UE 103 can move between different networks. For example, the UE 103 can move from a first NTN cell (e.g., a cell associated with the first NTN) to a second NTN cell (e.g., a cell associated with the second NTN different from the first NTN). In another example, the UE 103 can move from the NTN cell to a TN cell (e.g., a cell associated with the TN). In another example, the UE 103 can move from the TN cell to the NTN cell. System 100 can be configured to facilitate the RACH-less handover for the UE 103. FIGS. 1B-1E are discussed below for exemplary RACH-less handover of the UE 103 between a first NTN cell and a second NTN cell. However, the aspects of this disclosure are not limited to these examples and be applied to other RACH-less handovers.

In some aspects, the UE 103 is not required to connect to both an NTN and TN cell simultaneously during handovers. In some examples, Dual Active Protocol Stack (DAPS) is not supported. In some aspects, additional conditions for conditional handover (CHO) are introduced for NTN specific CHO due to the NTN radio characteristics. For example, for NTN specific characteristics, the variation in signal strength/quality between cell-center and cell-edge is not very pronounced. For NTN specific CHO conditions, condEventT1 and condEventD1 can always be configured together with one of the measurement-based trigger conditions (e.g., CHO events A3/A4/A5).

According to some aspects, for the CHO recovery and for the candidate cell with condEventT1, CHO recovery cannot be executed if a timer T2 has not expired. For the candidate cell with condEventD1, CHO recovery can be excluded without checking condEventD1. In some examples, condEventD1 can be configured as the normal measurement event for measurement report. In some aspects, condEventT1 and condEventD1 are discussed in, for example, 3^{rd} Generation Partnership Project (3GPP) Technical Specification (TS) ETSI TS 138 331 V17.0.0 (2022 May).

In some examples, the NTN CHO condition can include condEventA4 that can be used for measurement event A4 (e.g., a neighbour becomes better than a threshold). In some examples, the NTN CHO condition can include condEventT1 that can be a time-based trigger condition and the CHO can be executed only between T1 and T2. In these examples, the network can configure T1 (e.g., the t1-threshold) and duration (duration) using Coordinated Universal Time (UTC) time. In some examples, the NTN CHO condition can include condEventD1 that can be a location-based trigger condition. The CHO can be executed when the following two conditions are fulfilled—(1) a distance between the UE (e.g., the UE 103) and a first reference location (e.g., referenceLocation1) is greater than a distance threshold from a first reference (e.g., distanceThreshFromReference1) (away from a primary serving cell (PCell)) and (2) a distance between the UE (e.g., the UE 103) and a second reference location (e.g., referenceLocation2) is smaller than a distance threshold from a second reference (e.g., distanceThreshFromReference2).

According to some aspects, the RACH-less handover includes a handover procedure that does not use (and/or skips) the RACH procedure. The NTN RACH-less handover can support dynamic grant from the target cell for RACH-less Physical uplink shared channel (PUSCH) transmission to reduce random access congestion in the target cell. In some examples, the RACH-less handover in can be a layer 3 (L3) mobility procedure and can use the Long Term Evolution (LTE) RACH-less handover procedure as a baseline. In the LTE RACH-less handover procedure, the network provides the absolute TA value for access in the target cell, and UE can apply the indicated value directly. However, for the NTN, only part of the TA value is known by the network side, and the other part is calculated by UE itself. Therefore, the TA value provided by the LTE RACH-less handover procedure has shortcomings for the NTN RACH-less handover procedure.

Accordingly, as discussed in more detail below, some aspects of this disclosure are directed to RACH-less handover for NTN where the UE can receive a TA configuration and the UE can use the TA configuration to determine (e.g., compute and/or derive) the TA value. As discussed in more detail below, the UE can use different values in the TA configuration to determine (e.g., compute and/or derive) the TA value based on different RACH-less handover scenarios.

According to some aspects, when the UE 103 moves from a first NTN cell to a second NTN cell (different from the first NTN cell), the UE 103 is configured to determine (e.g., compute and/or derive) a timing advance (TA) value for the second NTN cell. The UE 103 can use the TA value to control the uplink transmission timing of the UE 103 within the second NTN cell. Therefore, the uplink transmissions from all UEs can be synchronized when the uplink transmissions are received by, for example, a base station (BS). As discussed in more detail below, the UE 103 can receive a TA configuration and the UE 103 can use the TA configuration to determine (e.g., compute and/or derive) the TA value.

Although some examples are discussed herein as a handover between NTN cells, the aspects of this disclosure are not limited to these examples and can include other handovers (e.g., between an NTN cell and a TN cell).

FIGS. 1B-1E provide some exemplary RACH-less handovers of the UE 103 between a first NTN cell and a second NTN cell, according to some aspects.

FIG. 1B illustrates system 110 with one exemplary RACH-less handover of the UE 103 for an intra-satellite handover with the same feeder link (e.g., same base station 101). In this example, the UE 103 is connected to and communicates with the satellite 104 using the carrier 105. The satellite 104 is connected to and communicates with the base station 101 using the carrier 107. In a non-limiting example, the RACH-less handover for the UE 103 can include the UE 103 using the same carrier 105 (also referred herein as a service link) to connect to and communicate with the satellite 104. In this exemplary RACH-less handover, the satellite 104, the base station 101, the carrier 105, and the carrier 107 (also referred herein as a feeder link) remain the same (e.g., intra-satellite handover with the same feeder link). According to some aspects, the coverage area 108 can change after the RACH-less handover. Additionally, or alternatively, after the RACH-less handover, the coverage area 108 can remain the same as before the RACH-less handover.

As discussed in more detail below, during the RACH-less handover of FIG. 1B, the UE 103 can receive a TA configuration from the base station 101 through the satellite 104. The UE 103 can use the TA configuration to determine (e.g., compute and/or derive) the TA value for communicating with the base station 101 through the satellite 104 using carriers 105 and 107.

In contrast to using the same service link, some aspects of intra-satellite handover with the same feeder link can include scenarios where the service link is changed (e.g., from 105 to 115). In a non-limiting example, the RACH-less handover for the UE 103 can include the UE 103 using a new carrier 115 (also referred herein as a service link) to connect to and communicate with the satellite 104. In this exemplary RACH-less handover, the satellite 104, the base station 101, and the carrier 107 (also referred herein as a feeder link) remain the same (e.g., intra-satellite handover with the same feeder link). However, the carrier (in the service link) is changed from carrier 105 to carrier 115. The change in the carrier can be a change in the component carriers, a change in a frequency of the service link, or the like. According to some aspects, the coverage area 108 can change after the RACH-less handover. Additionally, or alternatively, after the RACH-less handover, the coverage area 108 can remain the same as before the RACH-less handover.

As discussed in more detail below, during the RACH-less handover of FIG. 1B, the UE 103 can receive a TA configuration from the base station 101 through the satellite 104. The UE 103 can use the TA configuration to determine (e.g., compute and/or derive) the TA value for communicating with the base station 101 through the satellite 104 through carriers 115 and 107.

FIG. 1C illustrates system 120 with one exemplary RACH-less handover of the UE 103 for an intra-satellite handover with different feeder links (e.g., different base stations). In this example, the UE 103 is connected to and communicates with the satellite 104 using the carrier 105. The satellite 104 is connected to and communicates with the base station 101 using the carrier 107. In a non-limiting example, the RACH-less handover for the UE 103 can include the UE 103 being connected to and communicating with a new base station 121. In this exemplary RACH-less handover, the satellite 104 remains the same, but the base station is changed from the base station 101 to the base station 121 (e.g., intra-satellite handover with different feeder links). After the handover, the UE 103 is still connected to and communicates with the satellite 104 using the carrier 105. Now, the satellite 104 is connected to and communicates with the base station 121 using the carrier 127. According to some aspects, the coverage area 108 can change after the RACH-less handover. Additionally, or alternatively, after the RACH-less handover, the coverage area 108 can remain the same as before the RACH-less handover.

As discussed in more detail below, during the RACH-less handover of FIG. 1C, the UE 103 can receive a TA configuration from the base station 101 through the satellite 104. The UE 103 can use the TA configuration to determine (e.g., compute and/or derive) the TA value for communicating with the base station 121 through the satellite 104 through carriers 105 and 127.

FIG. 1D illustrates system 130 with one exemplary RACH-less handover of the UE 103 for an inter-satellite handover with different feeder links (e.g., different base stations). In this example, the UE 103 is connected to and communicates with the satellite 104 using the carrier 105. The satellite 104 is connected to and communicates with the base station 101 using the carrier 107. In a non-limiting example, the RACH-less handover for the UE 103 can include the UE 103 being connected to and communicating with a new base station 131 through a new satellite 134. In this exemplary RACH-less handover, the satellite 104 is changed to the satellite 134 and the base station is changed from the base station 101 to the base station 131 (e.g., inter-satellite handover with different feeder links). After the handover, the UE 103 is now connected to and communicates with the satellite 134 using the carrier 135. The satellite 134 is connected to and communicates with the base station 131 using the carrier 137. According to some aspects, the coverage area 108 can change after the RACH-less handover to the coverage area 138. Additionally, or alternatively, after the RACH-less handover, the coverage area 108 can remain the same as before the RACH-less handover.

As discussed in more detail below, during the RACH-less handover of FIG. 1D, the UE 103 can receive a TA configuration from the base station 101 through the satellite 104. The UE 103 can use the TA configuration to determine (e.g., compute and/or derive) the TA value for communicating with the base station 131 through the satellite 134 through carriers 135 and 137.

FIG. 1E illustrates system 140 with one exemplary RACH-less handover of the UE 103 for an inter-satellite handover with the same feeder link (e.g., the same base station 101). In this example, the UE 103 is connected to and communicates with the satellite 104 using the carrier 105. The satellite 104 is connected to and communicates with the base station 101 using the carrier 107. In a non-limiting example, the RACH-less handover for the UE 103 can include the UE 103 being connected to and communicating with the same base station 101 through a new satellite 144. In this exemplary RACH-less handover, the satellite 104 is changed to the satellite 144 but the base station 101 remains the same (e.g., inter-satellite handover with the same feeder link). After the handover, the UE 103 is now connected to and communicates with the satellite 144 using the carrier 145. The satellite 144 is connected to and communicates with the base station 101 using the carrier 147. According to some aspects, the coverage area 108 can change after the RACH-less handover to the coverage area 148. Additionally, or alternatively, after the RACH-less handover, the coverage area 108 can remain the same as before the RACH-less handover.

As discussed in more detail below, during the RACH-less handover of FIG. 1E, the UE 103 can receive a TA configuration from the base station 101 through the satellite 104. The UE 103 can use the TA configuration to determine (e.g., compute and/or derive) the TA value for communicating with the base station 101 through the satellite 144 through carriers 105 and 147.

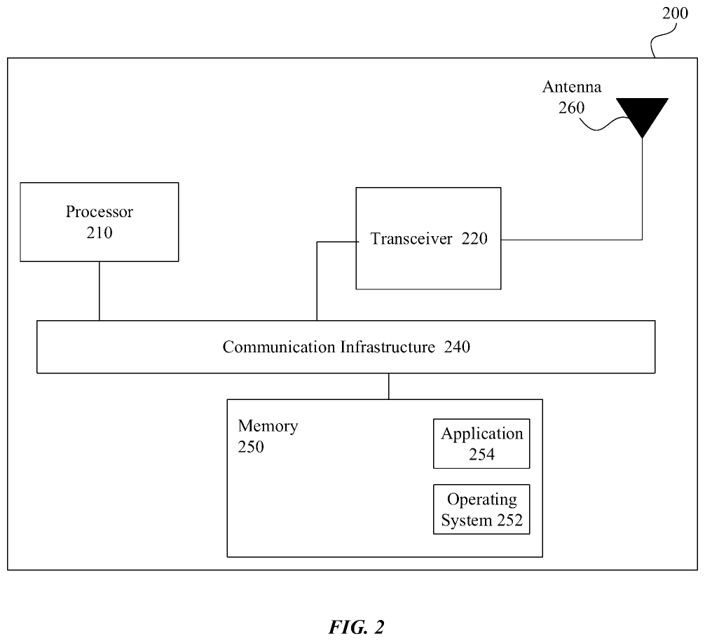

FIG. 2 illustrates a block diagram of an example system 200 of an electronic device implementing mechanisms for RACH-less handover for NTN, according to some aspects of the disclosure. System 200 may be any of the electronic devices (e.g., base stations 101, 121, 131, UE 103, satellites 104, 134, 144) of system 100, 110, 120, 130, and/or 140. System 200 includes a processor 210, one or more transceivers 220, a communication infrastructure 240, a memory 250, operating system 252, application 254, and/or one or more antennas 260. Illustrated systems are provided as exemplary parts of system 200, and system 200 can include other circuit(s) and subsystem(s). Also, although the systems of system 200 are illustrated as separate components, the aspects of this disclosure can include any combination of these, less, or more components. Also, system 200 of the aspects of this disclosure can include any number of processors, transceivers, communication infrastructures, memories, operating systems, applications, and antennas.

The memory 250 may include random access memory (RAM) and/or cache, and may include control logic (e.g., computer software) and/or data. The memory 250 may include other storage devices or memory such as, but not limited to, a hard disk drive and/or a removable storage device/unit. According to some examples, the operating system 252 can be stored in memory 250. The operating system 252 can manage transfer of data between the memory 250, one or more applications 254, the processor 210, and/or one or more transceivers 220. In some examples, the operating system 252 maintains one or more network protocol stacks (e.g., Internet protocol stack, cellular protocol stack, and the like) that can include a number of logical layers. At corresponding layers of the protocol stack, the operating system 252 includes control mechanism and data structures to perform the functions associated with that layer.

According to some examples, the application 254 can be stored in the memory 250. The application 254 can include applications (e.g., user applications) used by wireless system 200 and/or a user of wireless system 200. The applications in the application 254 can include applications such as, but not limited to, radio streaming, video streaming, remote control, and/or other user applications.

System 200 can also include the communication infrastructure 240. The communication infrastructure 240 provides communication between, for example, the processor 210, the one or more transceivers 220, and the memory 250. In some implementations, the communication infrastructure 240 may be a bus. The processor 210 together with instructions stored in memory 250 performs operations enabling system 200 of systems 100-140 to implement mechanisms for RACH-less handover for NTN, as described herein.

The one or more transceivers 220 transmit and receive communications signals that support the operations of system 200 including, but not limited to, mechanisms for RACH-less handover for NTN, according to some aspects, and may be coupled to the one or more antennas 260. The one or more antennas 260 may include one or more antennas that may be the same or different types. The one or more antennas 260 may include one or more MIMO antenna(s) having one or more antenna ports. According to some aspects, each antenna port of the one or more antennas 260 can carry its resource grid and one or more reference signals. The antenna ports of the one or more antennas 260 can be indicated using port numbers. Different antenna ports can be assigned to different channels and/or signals.

The one or more transceivers 220 allow system 200 to communicate with other devices that may be wired and/or wireless. In some examples, the one or more transceivers 220 can include processors, controllers, radios, sockets, plugs, buffers, and like circuits/devices used for connecting to and communication on networks. According to some examples, the one or more transceivers 220 include one or more circuits to connect to and communicate on wired and/or wireless networks.

According to some aspects, the one or more transceivers 220 can include a cellular subsystem, a WLAN subsystem, and/or a Bluetooth™ subsystem, each including its own radio transceiver and protocol(s) as will be understood by those skilled arts based on the discussion provided herein. In some implementations, the one or more transceivers 220 can include more or fewer systems for communicating with other devices.

In some examples, the one or more transceivers 220 can include one or more circuits (including a WLAN transceiver) to enable connection(s) and communication over WLAN networks such as, but not limited to, networks based on standards described in IEEE 802.11. Additionally, or alternatively, the one or more transceivers 220 can include one or more circuits (including a Bluetooth™ transceiver) to enable connection(s) and communication based on, for example, Bluetooth™ protocol, the Bluetooth™ Low Energy protocol, or the Bluetooth™ Low Energy Long Range protocol. For example, transceiver 220n can include a Bluetooth™ transceiver.

Additionally, the one or more transceivers 220 can include one or more circuits (including a cellular transceiver) for connecting to and communicating on cellular networks. The cellular networks can include, but are not limited to, 3G/4G/5G networks such as Universal Mobile Telecommunications System (UMTS), Long-Term Evolution (LTE), and the like. For example, the one or more transceivers 220a-220n can be configured to operate according to one or more of Rel-15, Rel-16, Rel-17, Rel-17 NR, Rel-17 NTN, Rel-18, Rel-18 NR, Rel-18 NTN, or other of the 3GPP standards.

According to some aspects, the processor 210, alone or in combination with computer instructions stored within the memory 250, and/or the one or more transceiver 220, implements mechanisms for RACH-less handover for NTN, as discussed herein.

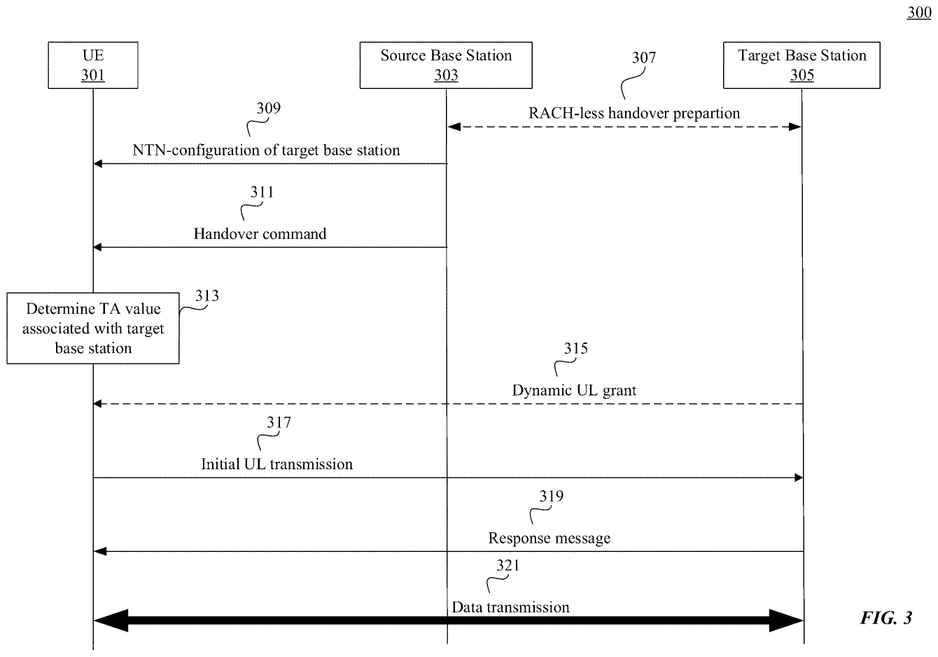

FIG. 3 illustrates communications 300 between a UE, a source base station, and a target base station for implementing RACH-less handover for NTN, according to some aspects. As a convenience and not a limitation, FIG. 3 may be described with regard to elements of FIGS. 1A-1E and 2. It is to be appreciated that not all operations of FIG. 3 may be needed, and the operations may not be performed in the same order as shown in FIG. 3.

According to some aspects, the UE 301 is connected to and communicates with source the base station 303. The UE 301 can the UE 103 of FIGS. 1A-1E. The source base station 303 can be the base station 101 of FIGS. 1A-1E. The source base station 303 can be associated a source cell where the UE 301 is operating at. The source cell can be an NTN cell or a TN cell. As the UE 301 moves to a target cell associated with the target base station 305, the RACH-less handover procedure is perform such that the UE 301 is handover from the source base station 303 to the target base station 305. The target cell can be an NTN cell or a TN cell. According to some aspects, the target cell is an NTN cell and the source cell is also an NTN cell. In some aspects, the target cell is an NTN cell and the source cell is also TN cell. According to some aspects, the UE 301 supports the RACH-less handover in NTN, and both the source base station 303 and the target base station 305 support RACH-less handover.

According to some aspects, the source base station 303 and the target base station 305 can perform a RACH-less handover preparation 307. In some examples, during the RACH-less handover preparation 307, the source base station 303 can receive measurement(s) from the UE 301 and, depending on the received measurement(s) and network conditions, the source base station 303 can send a handover request to the target base station 305. The target base station 305 can accept or reject the handover request. The target base station 305 can send a handover request response to the source base station 305. The RACH-less handover preparation 307 can include other (and/or different) operations between the source base station 303 and the target base station 305.

According to some aspects, then the source base station 303 can send the NTN-configuration 309 of the target base station 305 to the UE 301. In some examples, the NTN-configuration 309 can include a system information block type 19 (SIB19). The SIB19 can include, but is not limited to, inter-radio access technology (RAT) frequency and priority information to be used in the target cell associated with the target base station 305. However, the aspects of this disclosure are not limited to this example and the NTN-configuration 309 of the target base station 305 can include other information.

According to some aspects, the source base station 303 can then send the handover command 311 to the UE 301. The handover command 311 can include a RACH-less handover command that the source base station 303 can use to indicate to the UE 301 to handover to the target base station 305. According to some aspects, the handover command 311 can include uplink (UL) resource information for the UE 301 to connect to and communicate with the target base station 305. Additionally, or alternatively, the handover command 311 can include UL grant for the target base station 305. Additionally, or alternatively, the handover command 311 can include TA configuration associated with the target base station 305. However, the aspects of this disclosure are not limited to this example and the handover command 311 can include other (and/or different) information.

Although FIG. 3 illustrates that the TA configuration associated with the target base station 305 is provided using the handover command 311, other methods can be used to provide the TA configuration associated with the target base station 305 to the UE 301. For example, the TA configuration associated with the target base station 305 can be provided to the UE 301 in advance (e.g., during the RACH-less handover preparation 307 or before the RACH-less handover preparation 307).

After receiving the handover command 311, the UE 301 determines (e.g., computes and/or derives) at 313 the TA value associated with the target base station 305 based on the information in the handover command 311. For example, the UE 301 determines (e.g., computes and/or derives) the TA value associated with the target base station 305 based on the TA configuration associated with the target base station 305 provided in the handover command 311. The UE 301 can use the determined TA value for the UE 301 UL transmission to the target base station 305.

According to some aspects, the communication 300 can include an optional dynamic UL grant 315. For example, the target base station 305 can transmit the dynamic UL grant 315 to the UE 301. The dynamic UL grant 315 can include an UL grant for the first UL transmission of the UE 301 in the target cell associated with the target base station 305. The dynamic UL grant 315 can include a dynamic schedule for the UL grant. Additionally, or alternatively to, the optional dynamic UL grant 315, the UL grant for the first UL transmission of the UE 301 in the target cell can be provided in the handover command 311 (e.g., an radio resource control (RRC) preallocated configured grant).

According to some aspects, the UE 301 can transmit the initial UL transmission 317. The UE 301 can use the TA value determined (e.g., computed and/or derived) in operation 313 for the initial UL transmission 317. The UE 301 can use the granted UL resource (based on dynamic UL grant 315 and/or handover command 311) for the initial UL transmission 317. The UE 301 can perform the initial UL transmission 317 during the first valid PUSCH resource. In some examples, the initial UL transmission 317 can include a handover complete message. For example, the UE 301 sends the initial UL transmission 317 (e.g., the handover complete message) to the target base station 305 to indicate to the target base station 305 that the UE 301 is now connected to and communicates with the target base station 305.

As indicated in FIG. 3, the communication 300 does not include a RACH procedure between handover command 311 and the initial UL transmission 317. The handover procedure of FIG. 3 is a RACH-less handover procedure.

According to some aspects, and in response to the initial UL transmission 317, the target base station 305 can transmit response message 319 to the UE 301. According to some aspects, the response message 319 can be a confirmation response message confirming the receipt of the initial UL transmission 317. According to some aspects, the response message 319 can be any response message. For example, the confirmation message 319 can include a medium access control (MAC) control element (CE). In some examples, the MAC CE can include a contention resolution (CR) MAC CE. In some examples, the MAC CE can include a tracking area code (TAC) MAC CE. In some examples, the MAC CE can include a UE dedicated MAC CE.

According to some aspects, after receiving the response message 319, the UE 301 can start the data transmission 321 with the target base station 305 (e.g., in the target cell).

As discussed above, the UE 301 determines (e.g., computes and/or derives) at 313 the TA value associated with the target base station 305 based at least on the TA configuration associated with the target base station 305 provided in the handover command 311. The UE 301 can use TA value for the initial UL transmission 317 and/or for the data transmission 321. For example, an UL frame for transmission from the UE 301 starts the TA value before the start of the corresponding downlink frame at the UE 301. According to some aspects, the TA value can be computed as:

$${T}_{T A} = ( {N}_{T A} + {N}_{TA , offset} + {N}_{TA , adj}^{c o m m o n} + {N}_{TA , adj}^{U E} ) {T}_{c} \qquad Equation ( 1 )$$

Here, T_{TA} is the TA value that is determined (e.g., computed and/or derived) by the UE 301. T_{c} is a sampling time and can depend on subcarrier spacing. In some examples, T_{c}=0.509 ns. However, other values for T_{c} can be used.

An initial time alignment value (N_{TA}) and a TA offset value (N_{TA,offset}) can be provided by and/or computed from, for example, clause 4.2 of ETSI TS 138 213 V15.3.0 (2018 October) (Physical layer procedures for control (3GPP TS 38.213 version 15.3.0 Release 15)).

A common TA value

$$( {N}_{TA , adj}^{c o m m o n} )$$

can be provided by and/or computed from, for example, clause 4.2 of ETSI TS 138 213 V15.3.0 (2018 October) and can be derived from the higher-layer parameters TACommon, TACommonDrift, and TACommonDriftVariation if configured. Otherwise,

$${N}_{TA , adj}^{c o m m o n} = 0 .$$

In some examples, the UE 301 can determine the common TA value

$$( {N}_{TA , adj}^{c o m m o n} )$$

based on a one-way propagation delay as provided in, for example, clause 4.2 of ETSI TS 136 213 V17.2.0 (2022 August) (LTE; Evolved Universal Terrestrial Radio Access (E-UTRA); Physical layer procedures (3GPP TS 36.213 version 17.2.0 Release 17)). UE 301 can determine the common TA value

$$( {N}_{TA , adj}^{c o m m o n} )$$

based on NTN-configuration of a serving satellite (e.g., based on a feeder link delay). For example, the one-way propagation delay (Delay_{common}(t)) can be determined as follows:

$${Delay}_{c o m m o n} ( t ) = \frac{T {A}_{Common}}{2} + \frac{T {A}_{C o m m o n Drif}}{2} * ( t - {t}_{epoch} ) + \frac{T {A}_{C o m m o n DrifVarian}}{2} * {( t - {t}_{e p o c h} )}^{2} \qquad Equation ( 2 )$$

Here, TA_{common}, TA_{CommonDrift}, and TA_{CommonDriftVariant} are respectively provided by ta-Common, ta-CommonDrift, and ta-CommonDriftVariant and t_{epoch} is the epoch time of TA_{Common}, TA_{CommonDrift}, and TA_{CommonDriftVariant} as discussed in, for example, TS 38.331. The one-way propagation delay (Delay_{common}(t)) can provide a distance at time t between a serving satellite and an uplink time synchronization reference point divided by the speed of time. The uplink reference point can be a point where downlink (DL) and UL are frame aligned with an offset given by the TA offset value (N_{TA,offset}).

According to some aspects, the NTN configuration used for TA value calculation can be provided in the NTN-configuration. In some aspects, for the serving cell, the NTN-configuration is provided in an RRC dedicated configuration and/or the SIB19. In some aspects, for a neighbor cell, NTN-configuration can be provided in the SIB19. In some aspects, the network can use TAC MAC CE to adjust the initial time alignment value (N_{TA}) value, which can be common as TN and NTN cell.

A UE specific TA value

$$( {N}_{TA , adj}^{U E} )$$

can be given and/or computed by, for example, clause 4.2 of ETSI TS 138 213 V15.3.0 (2018 October) and is computed by the UE 301 based on UE 301 position and serving-satellite-ephemeris-related higher-layers parameters if configured. Otherwise,

$${N}_{TA , adj}^{U E} = 0 .$$

The UE can calculate the UE specific TA value

$$( {N}_{TA , adj}^{U E} )$$

based on the UE position and ephemeris-information of the serving satellite (e.g., using the service link delay).

According to some aspects, the TA value (T_{TA}) is a combination of service link round-trip time (RTT) and a common TA. The service link RTT is the RTT on the service link between the UE (e.g., UE 301) and the satellite with which the UE communicates. For example, the service link RTT is the RTT on the service link between the UE 103 and the satellite 104 of FIG. 1A. The common TA is a configured offset that corresponds to the RTT between a Reference Point (RP) and an NTN payload. The RP can be located between the satellite (e.g., the satellite 104 of FIG. 1A) and a base station (e.g., the base station 101 of FIG. 1A). The common TA can be part of a feeder link RTT. The feeder link RTT is the RTT on the feeder link between the satellite (e.g., the satellite 104 of FIG. 1A) and the base station (e.g., the base station 101 of FIG. 1A).

According to some aspects, the UE 301 determines (e.g., computes and/or derives) at 313 the TA value associated with the target base station 305 based at least on the TA configuration associated with the target base station 305 provided in the handover command 311 using different options.

Option 1—According to some aspects, the source base station 305 can indicate to the UE 301 (e.g., using the TA configuration in the handover command 311) to use the source Primary serving Cell (PCell) TA value for UL transmissions to the target base station 305. The source PCell is, and/or is associated with, the source base station 305. For example, the TA configuration in the handover command 311 can include the TA value (T_{TA}) of the target base station 305 that reuses the source PCell TA value. Additionally, or alternatively, the TA configuration in the handover command 311 can include information (e.g., one or more parameters) to indicate to the UE 301 to use the source PCell TA value for UL transmissions to the target base station 305.

In this case, the UE 301 uses the current TA value in the source PCell for the transmissions in the target cell (e.g., to the target base station 305) directly. In other words, determining (e.g., computing and/or deriving) the TA value can include determining that the TA configuration in the handover command 311 includes the source PCell's TA value and can further include using the source PCell's TA value for the transmissions in the target cell. Additionally, or alternatively, determining (e.g., computing and/or deriving) the TA value can include determining the information (e.g., one or more parameters) in the TA configuration in the handover command 311 that indicates to use the source PCell's TA value. In this exemplary aspect, determining (e.g., computing and/or deriving) the TA value can further include using the current TA value (the source PCell's TA value that the UE 301 is using for the source cell) for the transmissions in the target cell.

Option 2—According to some aspects, the source base station 305 can indicate to the UE 301 (e.g., using the TA configuration in the handover command 311) which parameters of the TA value to reuse from the source PCell and which parameters of the TA value to compute. For example, the TA configuration in the handover command 311 can indicate to the UE 301 whether the common TA value

$$( {N}_{TA , adj}^{c o m m o n} ) ,$$

the UL specific TA value

$$( {N}_{TA , adj}^{UE} ) ,$$

and the initial time alignment value (N_{TA}) are the same as the corresponding values used for the source PCell's TA. The source PCell is, and/or is associated with, the source base station 305. The TA configuration in the handover command 311 can indicate to the UE 301 regarding one or more of the common TA value

$$( {N}_{TA , adj}^{common} ) ,$$

the UE specific TA value

$$( {N}_{TA , adj}^{UE} ) ,$$

or the initial time alignment value (N_{TA}) separately.

In some examples, the TA configuration can indicate whether the common TA value

$$( {N}_{TA , adj}^{common} ) ,$$

the UE specific TA value

$$( {N}_{TA , adj}^{UE} ) ,$$

and/or the initial time alignment value (N_{TA}) are the same as the corresponding values used for the source PCell's TA by using the same corresponding values used for the source PCell's TA. Additionally, or alternatively, the TA configuration can indicate whether the common TA value

$$( {N}_{TA , adj}^{common} ) ,$$

the UE specific TA value

$$( {N}_{TA , adj}^{UE} ) ,$$

and/or the initial time alignment value (N_{TA}) are the same as the corresponding values used for the source PCell's TA by using parameters in the TA configuration to indicate whether same information is being used or not. For example, the TA configuration can indicate whether the common TA value

$$( {N}_{TA , adj}^{common} ) ,$$

the UE specific TA value

$$( {N}_{TA , adj}^{UE} ) ,$$

and/or the initial time alignment value (N_{TA}) are the same as the corresponding values used for the source PCell's TA by the absence or the presence of that parameter.

In some examples, for the initial time alignment value (N_{TA}), the TA configuration can also indicate whether the initial time alignment value (N_{TA}) is 0.

Depending on the information in the TA configuration of the handover command 311, the UE 301 can use Equation (1) to determine (e.g., compute and/or derive) the TA value for UL transmissions to the target base station 305.

In one example, the common TA value

$$( {N}_{TA , adj}^{common} ) ,$$

the UE specific TA value

$$( {N}_{TA , adj}^{UE} ) ,$$

and the initial time alignment value (N_{TA}) are the same as the corresponding values/parameters used for the source PCell's TA. The UE 301 can use this information (e.g., the corresponding values/parameters used for the source PCell's TA) and Equation (1) to determine (e.g., compute and/or derive) the TA value for UL transmissions to the target base station 305. In some examples, the UE 301 can also compute/derive the TA offset value (N_{TA,offset}) to use in Equation (1). This example can be used for intra-satellite handover with the same feeder link, according to some aspects.

In another example, the UE specific TA value

$$( {N}_{TA , adj}^{UE} )$$

and the initial time alignment value (N_{TA}) are the same as the corresponding values/parameters used for the source PCell's TA. The UE 301 can use this information (e.g., the corresponding values/parameters used for the source PCell's TA), compute/derive the common TA value

$$( {N}_{TA , adj}^{common} ) ,$$

and use Equation (1) to determine (e.g., compute and/or derive) the TA value for UL transmissions to the target base station 305. In some examples, the UE 301 can also compute/derive the TA offset value (N_{TA,offset}) to use in Equation (1). This example can be used for intra-satellite handover with differ feeder links (e.g., applicable on GSO), according to some aspects.

In another example, the common TA value

$$( {N}_{TA , adj}^{common} )$$

is the same as the corresponding value/parameter used for the source PCell's TA. The UE 301 can use this information (e.g., the corresponding value/parameter used for the source PCell's TA), compute/derive the UE specific TA value

$$( {N}_{TA , adj}^{UE} ) ,$$

and the initial time alignment value (N_{TA}), and use Equation (1) to determine (e.g., compute and/or derive) the TA value for UL transmissions to the target base station 305. In some examples, the UE 301 can also compute/derive the TA offset value (N_{TA,offset}) to use in Equation (1). This example can be used for handover with the same feeder link, according to some aspects.

According to some examples, the UE specific TA value

$$( {N}_{TA , adj}^{UE} )$$

and the initial time alignment value (N_{TA}) are both the same as the corresponding value/parameter used for the source PCell's TA or both are different than the corresponding value/parameter used for the source PCell's TA.

According to some aspects, if the feeder links are the same in the handover, the common TA value

$$( {N}_{TA , adj}^{common} )$$

remains the same and does not change. Also, if the service links are the same in the handover (e.g., intra-satellite handover), the UE specific TA value

$$( {N}_{TA , adj}^{UE} )$$

remains the same and does not change.

Option 3—According to some aspects, the source base station 305 does not provide any information regarding parameters of the TA value to the UE 301. For example, the TA configuration in the handover command 311 does not include any information regarding parameters of the TA value. The TA configuration (and/or the handover command 311) can include information indicating that the RACH-less handover operation, but does not include information regarding parameters of the TA value.

In this example, the UE 301 assumes that the initial time alignment value (N_{TA}) has a value of 0 (N_{TA}=0). The UE 301 computes/derives the common TA value

$$( {N}_{TA , adj}^{common} ) ,$$

the UE specific TA value

$$( {N}_{TA , adj}^{UE} ) ,$$

and/or the TA offset value (N_{TA,offset}). Then, the UE 301 uses Equation (1) to determine (e.g., compute and/or derive) the TA value for UL transmissions to the target base station 305.

Option 4—According to some aspects, the source base station 305 can indicate to the UE 301 (e.g., using the TA configuration in the handover command 311) what handover scenario/type is being used for the RACH-less handover. For example, the TA configuration in the handover command 311 can indicate whether the RACH-less handover is an intra-satellite handover with the same feeder link, an intra-satellite handover with different feeder links, an inter-satellite handover with different feeder links, or an inter-satellite handover with the same feeder links. In some examples, the TA configuration in the handover command 311 can use one or more parameters to indicate the handover scenario/type.

The UE 301 can use the parameters in the TA configuration in the handover command to determine which parameters of the TA value the UE 301 can reuse from the source PCell TA value and which parameters of the TA value the UE 301 computes/derives. The source PCell is, and/or is associated with, the source base station 305.

In some examples, for the intra-satellite handover, the UE 301 can use the UE specific TA value

$$( {N}_{TA , adj}^{UE} )$$

of the source PCell TA value. The UE 301 can compute/derive the other parameters (e.g., the initial time alignment value (N_{TA}), the common TA value

$$( {N}_{TA , adj}^{common} ) ,$$

and the TA offset value (N_{TA,offset})). Then, the UE 301 can use Equation (1) to determine (e.g., compute and/or derive) the TA value for UL transmissions to the target base station 305.

In some examples, for the inter-satellite handover, the UE 301 computes/derives the UE specific TA value

$$( {N}_{TA , adj}^{UE} ) .$$

The UE 301 can compute/derive the other parameters (e.g., the initial time alignment value (N_{TA}), the common TA value

$$( {N}_{TA , adj}^{common} ) ,$$

and the TA offset value (N_{TA,offset})). Then, the UE 301 can use Equation (1) to determine (e.g., compute and/or derive) the TA value for UL transmissions to the target base station 305.

In some examples, for the same feeder link handover, the UE 301 can use the common TA value

$$( {N}_{TA , adj}^{common} )$$

of the source PCell TA value. The UE 301 can compute/derive the other parameters (e.g., the initial time alignment value (N_{TA}), the UE specific TA value

$$( {N}_{TA , adj}^{UE} ) ,$$

and the TA offset value (N_{TA,offset})). Then, the UE 301 can use Equation (1) to determine (e.g., compute and/or derive) the TA value for UL transmissions to the target base station 305.

In some examples, for the different feeder links handover, the UE 301 computes/derives the common TA value

$$( {N}_{TA , adj}^{common} ) .$$

The UE 301 can compute/derive the other parameters (e.g., the initial time alignment value (N_{TA}), the UE specific TA value

$$( {N}_{TA , adj}^{UE} ) ,$$

and the TA offset value (N_{TA,offset})). Then, the UE 301 can use Equation (1) to determine (e.g., compute and/or derive) the TA value for UL transmissions to the target base station 305.

According to some aspects, different Options discussed above can be used with different handover scenarios/types.

In a non-limiting example, if the RACH-less handover is an intra-satellite handover with the same feeder link, Options 1, 2, and/or 4 can be used as these options can help the UE 301 to skip all or part of the TA value calculation. For example, with Option 1, the source base station 303 can indicate the TA value of source PCell can be reused for the target base station 305. With Option 2, the source base station 303 can set all the parameters of the TA value to be the same as the corresponding parameters of source PCell TA value. With Option 4, the source base station 305 can indicate that the RACH-less handover is an intra-satellite handover with the same feeder link.

In another non-limiting example, if the RACH-less handover is an intra-satellite handover with different feeder links, Options 2 and 4 can be used. For example, with Option 2, the source base station can indicate that the initial time alignment value (N_{TA}) and the UE specific TA value

$$( {N}_{TA , adj}^{UE} )$$

of the TA value for the target base station 305 are the same the corresponding parameters of source PCell TA value. With Option 4, the source base station 305 can indicate that the RACH-less handover is an intra-satellite handover with the different feeder links.

In another non-limiting example, if the RACH-less handover is an inter-satellite handover with different feeder links, Options 3 and 4 can be used. For example, with Option 3, the source base station 305 does not indicate any parameters in the TA configuration, and the UE 301 will perform the TA determination (e.g., computation and/or derivation) according to Equation (1). With Option 4, the source base station 305 can indicate that the RACH-less handover is an inter-satellite handover with different feeder links.

In another non-limiting example, if the RACH-less handover an inter-satellite handover with the same feeder link, Option 2 and 4 can be used. For example, with Option 2, the source base station can indicate that the common TA value

$$( {N}_{TA , adj}^{common} )$$

of the TA value for the target base station 305 is the same the corresponding parameter of source PCell TA value. With Option 4, the source base station 305 can indicate that the RACH-less handover is an inter-satellite handover with the same feeder link.

However, the aspects of this disclosure are not limited to these examples and other Options 1-4 can be applied to different handover scenarios/types.

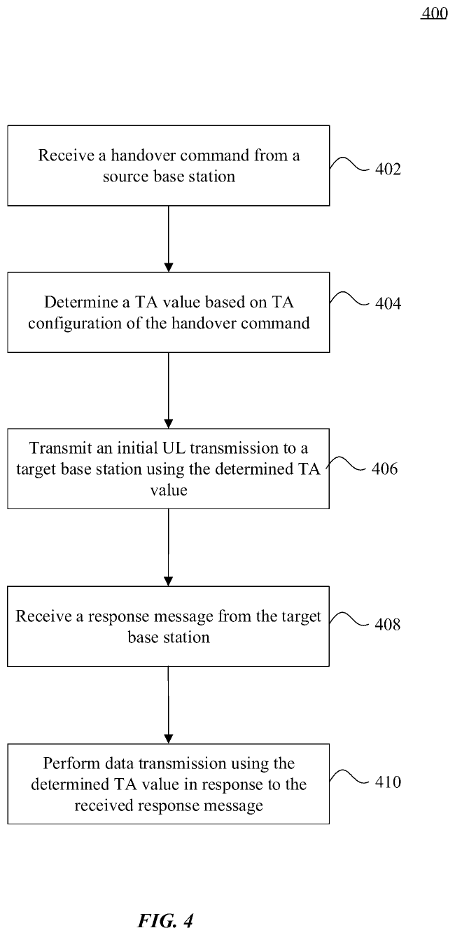

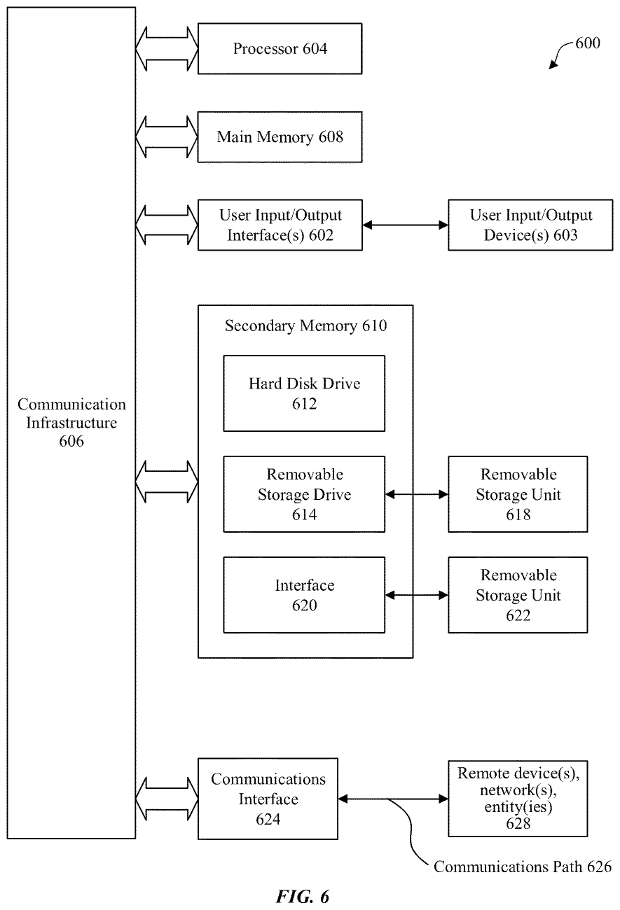

FIG. 4 illustrates an example method 400 for a system (for example, a UE) performing mechanisms for RACH-less handover for NTN, according to some aspects of the disclosure. As a convenience and not a limitation, FIG. 4 may be described with regard to elements of FIGS. 1-3. Method 400 may represent the operation of an electronic device (for example, UE 103 of FIG. 1A and/or UE 301 of FIG. 3) implementing mechanisms for RACH-less handover for NTN. Method 400 may also be performed by system 200 of FIG. 2 and/or computer system 600 of FIG. 6. But method 400 is not limited to the specific aspects depicted in those figures and other systems may be used to perform the method as will be understood by those skilled in the art. It is to be appreciated that not all operations may be needed, and the operations may not be performed in the same order as shown in FIG. 4.

At 402, a handover command is received from a source base station. For example, a UE (e.g., the UE 301) receives, from the source base station (e.g., the source base station 303), a handover command to perform a Random Access Channel (RACH)-less handover operation to a target base station (e.g., the target base station 305). In some aspects, the handover command can include a timing advance (TA) configuration.

At 404, a TA value is determined based on the TA configuration of the handover command. For example, the UE can determine (e.g., compute and/or derive), based on the TA configuration of the handover command, the TA value for uplink (UL) transmission to the target base station. According to some aspects, the UE can use one or more Options 1-4 discussed above to determine (e.g., compute and/or derive) the TA value for the UL transmissions to the target base station.

According to some aspects (e.g., Option 1), the TA configuration indicates that a TA value associated with the source base station is to be used. In this example, determining the TA value for UL transmission to the target base station of operation 404 can include determining the TA value associated with the source base station and using the TA value associated with the source base station as the TA value for UL transmission to the target base station. In some aspects, determining the TA value associated with the source base station can include determining the TA value associated with the source base station that the UE was using when the UE was communicating with the source base station.

According to some aspects (e.g., Option 2), the TA configuration indicates one or more parameters of a TA value associated with the source base station that are to be used. In this example, determining the TA value for UL transmission to the target base station of operation 404 can include determining the one or more parameters of the TA value associated with the source base station and using the one or more parameters of the TA value associated with the source base station to compute the TA value for UL transmission to the target base station. In some aspects, determining the one or more parameters of the TA value associated with the source base station can include determining the one or more parameters of the TA value associated with the source base station that the UE was using when the UE was communicating with the source base station.

As discussed above with respect to Option 2, the one or more parameters of the TA value associated with the source base station that are to be used comprise one or more of a common TA value, a UE specific TA value, or an initial time alignment value.

According to some aspects (Option 3), the TA configuration indicates the RACH-less handover without providing information regarding the TA value for UL transmission to the target base station. In this example, determining the TA value for UL transmission to the target base station of operation 404 can include assuming that an initial time alignment value has a value of 0 and computing a common TA value, a UE specific TA value, and a TA offset value. Operation 404 can further include using the initial time alignment value, the common TA value, the UE specific TA value, and the TA offset value to compute the TA value for UL transmission to the target base station.

According to some aspects (Option 4), the TA configuration indicates a handover type that is being used for the RACH-less handover. In this example, determining the TA value for UL transmission to the target base station of operation 404 can include computing the TA value for UL transmission to the target base station based on the handover type indicated in the TA configuration.

At 406, an initial UL transmission to the target base station is performed using the determined TA value. For example, the UE transmits, to the target base station, the initial UL transmission based on the determined TA value. The initial transmission can include a handover complete message, data packets/frame, or the like.

At 408, a response message is receive from the target base station. For example, the UE receives, from the target base station, the response message confirming the RACH-less handover.

At 410, data transmission is performed using the determined TA value in response to the received response message. For example, the UE performs data transmission to the target base station based on the determined TA value. The data transmission can include transmitting data packets/frame, control packets/frame, or the like.

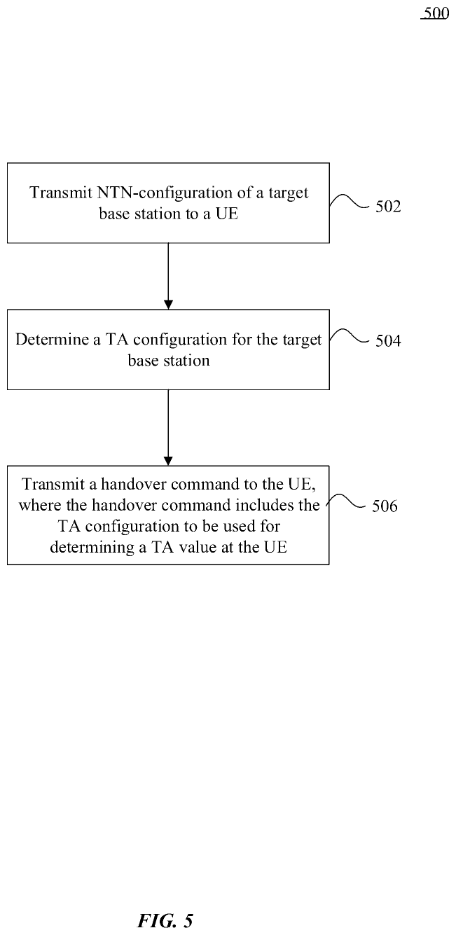

FIG. 5 illustrates an example method 500 for a system (for example, a base station) performing mechanisms for RACH-less handover for NTN, according to some aspects. As a convenience and not a limitation, FIG. 5 may be described with regard to elements of FIGS. 1-4. Method 500 may represent the operation of an electronic device (for example, base station 101 of FIG. 1A and/or source base station 303 of FIG. 3) performing mechanisms for RACH-less handover for NTN. Method 500 may also be performed by system 200 of FIG. 2 and/or computer system 600 of FIG. 6. But method 500 is not limited to the specific aspects depicted in those figures and other systems may be used to perform the method as will be understood by those skilled in the art. It is to be appreciated that not all operations may be needed, and the operations may not be performed in the same order as shown in FIG. 5.

At 502, an NTN-configuration of a target base station is transmitted to a UE. For example, a source base station (e.g., the source base station 303) transmits the NTN-configuration of the target base station (e.g., target base station 305) to the UE (e.g., the UE 301). The NTN-configuration can be the NTN-configuration 309 of FIG. 3 and can include a SIB19. The SIB19 can include RAT frequency and priority information to be used in the target cell associated with the target base station 305.

According to some aspects, before transmitting the NTN-configuration, the source base station and the target base station can perform preparation operation(s) for the RACH-less handover. The preparation operation(s) for the RACH-less handover can include the RACH-less handover preparation 307 of FIG. 3. The preparation operation(s) for the RACH-less handover can include, but is not limited to, receiving measurement(s) from the UE, sending a handover request to the target base station, and receiving a handover request response from the target base station.

At 504, a TA configuration for the target base station is determined. For example, the source base station can determine the TA configuration for the target base station. According to some aspects, the source base station can determine the TA configuration based on the NTN-configuration of the target base station. Additionally, or alternatively, the source base station can determine the TA configuration based on preconfigured information for the RACH-less handover. The source base station can use other methods for determining the TA configuration.

According to some aspects (e.g., Option 1), the source base station can determine and configure the TA configuration such that the TA configuration indicates that a TA value associated with the source base station is to be used by the UE.

According to some aspects (e.g., Option 2), the source base station can determine and configure the TA configuration such that the TA configuration indicates one or more parameters of a TA value associated with the source base station that are to be used by the UE. As discussed above with respect to Option 2, the one or more parameters of the TA value associated with the source base station that are to be used comprise one or more of a common TA value, a UE specific TA value, or an initial time alignment value.

According to some aspects (Option 3), the source base station can determine and configure the TA configuration such that the TA configuration indicates the RACH-less handover without providing information regarding the TA value for the UE UL transmission to the target base station.

According to some aspects (Option 4), the source base station can determine and configure the TA configuration such that the TA configuration indicates a handover type that is being used for the RACH-less handover.

After determining and configuring the TA configuration, the source base station can generate a handover command that include the TA configuration. At 506, the handover command is transmitted to the UE. For example, the source base station transmits the handover command to the UE, where the handover command includes the TA configuration to be used by the UE to determine a TA value.

Various aspects can be implemented, for example, using one or more computer systems, such as computer system 600 shown in FIG. 6. Computer system 600 can be any computer capable of performing the functions described herein such as devices 101, 103, 104, 121, 131, 134, and 144 of FIGS. 1A-1E, 200 of FIG. 2, and/or 301, 303, 305 of FIG. 3. Computer system 600 includes one or more processors (also called central processing units, or CPUs), such as a processor 604. Processor 604 is connected to a communication infrastructure 606 (e.g., a bus). Computer system 600 also includes user input/output device(s) 603, such as monitors, keyboards, pointing devices, etc., that communicate with communication infrastructure 606 through user input/output interface(s) 602. Computer system 600 also includes a main or primary memory 608, such as random access memory (RAM). Main memory 608 may include one or more levels of cache. Main memory 608 has stored therein control logic (e.g., computer software) and/or data.

Computer system 600 may also include one or more secondary storage devices or memory 610. Secondary memory 610 may include, for example, a hard disk drive 612 and/or a removable storage device or drive 614. Removable storage drive 614 may be a floppy disk drive, a magnetic tape drive, a compact disk drive, an optical storage device, tape backup device, and/or any other storage device/drive.

Removable storage drive 614 may interact with a removable storage unit 618. Removable storage unit 618 includes a computer usable or readable storage device having stored thereon computer software (control logic) and/or data. Removable storage unit 618 may be a floppy disk, magnetic tape, compact disk, DVD, optical storage disk, and/any other computer data storage device. Removable storage drive 614 reads from and/or writes to removable storage unit 618 in a well-known manner.

According to some aspects, secondary memory 610 may include other means, instrumentalities or other approaches for allowing computer programs and/or other instructions and/or data to be accessed by computer system 600. Such means, instrumentalities or other approaches may include, for example, a removable storage unit 622 and an interface 620. Examples of the removable storage unit 622 and the interface 620 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 600 may further include a communication or network interface 624. Communication interface 624 enables computer system 600 to communicate and interact with any combination of remote devices, remote networks, remote entities, etc. (individually and collectively referenced by reference number 628). For example, communication interface 624 may allow computer system 600 to communicate with remote devices 628 over communications path 626, which may be wired and/or wireless, and which may include any combination of LANs, WANs, the Internet, etc. Control logic and/or data may be transmitted to and from computer system 600 via communication path 626.

The operations in the preceding aspects can be implemented in a wide variety of configurations and architectures. Therefore, some or all of the operations in the preceding aspects may be performed in hardware, in software or both. In some aspects, a tangible, non-transitory apparatus or article of manufacture includes a tangible, non-transitory computer useable or readable medium having control logic (software) stored thereon is also referred to herein as a computer program product or program storage device. This includes, but is not limited to, computer system 600, main memory 608, secondary memory 610 and removable storage units 618 and 622, as well as tangible articles of manufacture embodying any combination of the foregoing. Such control logic, when executed by one or more data processing devices (such as computer system 600), causes such data processing devices to operate as described herein.

Based on the teachings contained in this disclosure, it will be apparent to persons skilled in the relevant art(s) how to make and use aspects of the disclosure using data processing devices, computer systems and/or computer architectures other than that shown in FIG. 6. In particular, aspects may operate with software, hardware, and/or operating system implementations other than those described herein.

It is to be appreciated that the Detailed Description section, and not the Summary and Abstract sections, is intended to be used to interpret the claims. The Summary and Abstract sections may set forth one or more, but not all, exemplary aspects of the disclosure as contemplated by the inventor(s), and thus, are not intended to limit the disclosure or the appended claims in any way.

While the disclosure has been described herein with reference to exemplary aspects for exemplary fields and applications, it should be understood that the disclosure is not limited thereto. Other aspects and modifications thereto are possible, and are within the scope and spirit of the disclosure. For example, and without limiting the generality of this paragraph, aspects are not limited to the software, hardware, firmware, and/or entities illustrated in the figures and/or described herein. Further, aspects (whether or not explicitly described herein) have significant utility to fields and applications beyond the examples described herein.

Aspects have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. In addition, alternative aspects may perform functional blocks, steps, operations, methods, etc. using orderings different from those described herein.

References herein to “one aspect,” “aspects” “an example,” “examples,” or similar phrases, indicate that the aspect(s) described may include a particular feature, structure, or characteristic, but every aspect may not necessarily include the particular feature, structure, or characteristic. Moreover, such phrases are not necessarily referring to the same aspect. Further, when a particular feature, structure, or characteristic is described in connection with an aspect, it would be within the knowledge of persons skilled in the relevant art(s) to incorporate such feature, structure, or characteristic into other aspects whether or not explicitly mentioned or described herein.

The breadth and scope of the disclosure should not be limited by any of the above-described exemplary aspects, but should be defined only in accordance with the following claims and their equivalents.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should only occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of, or access to, certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

What is claimed is:

1. A user equipment (UE), comprising:
a transceiver configured to enable wireless communication with a source base station; and
a processor communicatively coupled to the transceiver and configured to:
receive, using the transceiver and from the source base station, a handover command to perform a Random Access Channel (RACH)-less handover operation to a target base station, wherein the handover command comprises a timing advance (TA) configuration;
determine, based on the TA configuration of the handover command, a TA value for uplink (UL) transmission to the target base station; and
transmit, using the transceiver and to the target base station, an initial UL transmission based on the determined TA value.

2. The UE of claim 1, wherein the TA configuration indicates that a TA value associated with the source base station is to be used, and wherein to determine the TA value for UL transmission to the target base station, the processor is configured to:
determine the TA value associated with the source base station; and
use the TA value associated with the source base station as the TA value for UL transmission to the target base station.

3. The UE of claim 1, wherein the TA configuration indicates one or more parameters of a TA value associated with the source base station that are to be used, and wherein to determine the TA value for UL transmission to the target base station, the processor is configured to:
determine the one or more parameters of the TA value associated with the source base station; and
use the one or more parameters of the TA value associated with the source base station to compute the TA value for UL transmission to the target base station.

4. The UE of claim 3, wherein the one or more parameters of the TA value associated with the source base station that are to be used comprise one or more of a common TA value, a UE specific TA value, or an initial time alignment value.

5. The UE of claim 1, wherein the TA configuration indicates the RACH-less handover without providing information regarding the TA value for UL transmission to the target base station, and wherein to determine the TA value for UL transmission to the target base station, the processor is configured to:
assume that an initial time alignment value has a value of 0;
compute a common TA value, a UE specific TA value, and a TA offset value; and
use the initial time alignment value, the common TA value, the UE specific TA value, and the TA offset value to compute the TA value for UL transmission to the target base station.

6. The UE of claim 1, wherein the TA configuration indicates a handover type that is being used for the RACH-less handover, and wherein to determine the TA value for UL transmission to the target base station, the processor is configured to:
compute the TA value for UL transmission to the target base station based on the handover type indicated in the TA configuration.

7. The UE of claim 1, wherein the processor is further configured to:
receive, using the transceiver and from the target base station, a response message confirming the RACH-less handover; and
perform data transmission to the target base station based on the determined TA value.

8. A method performed by a user equipment (UE), the method comprising:
receiving, from a source base station, a handover command to perform a Random Access Channel (RACH)-less handover operation to a target base station, wherein the handover command comprises a timing advance (TA) configuration;
determining, based on the TA configuration of the handover command, a TA value for uplink (UL) transmission to the target base station; and
transmitting, to the target base station, an initial UL transmission based on the determined TA value.

9. The method of claim 8, wherein the TA configuration indicates that a TA value associated with the source base station is to be used, and wherein the determining the TA value for UL transmission to the target base station comprises:
determining the TA value associated with the source base station; and
using the TA value associated with the source base station as the TA value for UL transmission to the target base station.

10. The method of claim 8, wherein the TA configuration indicates one or more parameters of a TA value associated with the source base station that are to be used, and wherein the determining the TA value for UL transmission to the target base station comprises:
determining the one or more parameters of the TA value associated with the source base station; and
using the one or more parameters of the TA value associated with the source base station to compute the TA value for UL transmission to the target base station.

11. The method of claim 10, wherein the one or more parameters of the TA value associated with the source base station that are to be used comprise one or more of a common TA value, a UE specific TA value, or an initial time alignment value.

12. The method of claim 8, wherein the TA configuration indicates the RACH-less handover without providing information regarding the TA value for UL transmission to the target base station, and wherein the determining the TA value for UL transmission to the target base station comprises:
assuming that an initial time alignment value has a value of 0;
computing a common TA value, a UE specific TA value, and a TA offset value; and
using the initial time alignment value, the common TA value, the UE specific TA value, and the TA offset value to compute the TA value for UL transmission to the target base station.

13. The method of claim 8, wherein the TA configuration indicates a handover type that is being used for the RACH-less handover, and wherein the determining the TA value for UL transmission to the target base station comprises:
computing the TA value for UL transmission to the target base station based on the handover type indicated in the TA configuration.

14. The method of claim 8, further comprising:
receiving, from the target base station, a response message confirming the RACH-less handover; and
performing data transmission to the target base station based on the determined TA value.

15. A non-transitory computer-readable medium storing instructions that when executed by a processor of a user equipment (UE) cause the UE to perform operations comprising:
receiving, from a source base station, a handover command to perform a Random Access Channel (RACH)-less handover operation to a target base station, wherein the handover command comprises a timing advance (TA) configuration;
determining, based on the TA configuration of the handover command, a TA value for uplink (UL) transmission to the target base station;
transmitting, using the transceiver and to the target base station, an initial UL transmission based on the determined TA value;
receiving, from the target base station and in response to the initial UL transmission, a response message confirming the RACH-less handover; and
performing data transmission to the target base station based on the determined TA value.

16. The non-transitory computer-readable medium of claim 15, wherein the TA configuration indicates that a TA value associated with the source base station is to be used, and wherein the determining the TA value for UL transmission to the target base station comprises:
determining the TA value associated with the source base station; and
using the TA value associated with the source base station as the TA value for UL transmission to the target base station.

17. The non-transitory computer-readable medium of claim 15, wherein the TA configuration indicates one or more parameters of a TA value associated with the source base station that are to be used, and wherein the determining the TA value for UL transmission to the target base station comprises:
determining the one or more parameters of the TA value associated with the source base station; and
using the one or more parameters of the TA value associated with the source base station to compute the TA value for UL transmission to the target base station.

18. The non-transitory computer-readable medium of claim 17, wherein the one or more parameters of the TA value associated with the source base station that are to be used comprise one or more of a common TA value, a UE specific TA value, or an initial time alignment value.

19. The non-transitory computer-readable medium of claim 15, wherein the TA configuration indicates the RACH-less handover without providing information regarding the TA value for UL transmission to the target base station, and wherein the determining the TA value for UL transmission to the target base station comprises:
assuming that an initial time alignment value has a value of 0;
computing a common TA value, a UE specific TA value, and a TA offset value; and
using the initial time alignment value, the common TA value, the UE specific TA value, and the TA offset value to compute the TA value for UL transmission to the target base station.

20. The non-transitory computer-readable medium of claim 15, wherein the TA configuration indicates a handover type that is being used for the RACH-less handover, and wherein the determining the TA value for UL transmission to the target base station comprises:
computing the TA value for UL transmission to the target base station based on the handover type indicated in the TA configuration.
